(19) United States
(12) Patent Application Publication
(10) Pub. No.: US 2025/0174913 A1
(43) Pub. Date: May 29, 2025

(54) ARRAY ANTENNA MODULE AND WIRELESS COMMUNICATION DEVICE

(71) Applicant: Chiun Mai Communication Systems, Inc., New Taipei (TW)

(72) Inventors: SHU-WEI JHANG, New Taipei (TW); CHIA-HUNG SU, New Taipei (TW); CHANG-CHING HUANG, New Taipei (TW); PO-CHIH LIN, New Taipei (TW)

(21) Appl. No.: 18/963,626

(22) Filed: Nov. 28, 2024

(30) Foreign Application Priority Data
Nov. 29, 2023 (CN) 202311627036.8

(51) Int. Cl. H01Q 21/20; H01Q 21/00

(52) U.S. Cl. CPC H01Q 21/20; H01Q 21/0006

(57) ABSTRACT

An array antenna module and a wireless communication device are provided, the array antenna module includes a dielectric substrate, at least one transmitting antenna and at least one receiving antenna arranged adjacent to each other and arranged on the dielectric substrate, and at least one decoupling element arranged on the dielectric substrate, at least a part of the decoupling element is arranged between the transmitting antenna and the receiving antenna; the decoupling element includes a first decoupling element and a second decoupling element, the first decoupling element is arranged closer to the transmitting antenna; the second decoupling element is arranged closer to the receiving antenna.

### CROSS-REFERENCE TO RELATED APPLICATIONS

This application claims priority to Chinese Patent Application No. 202311627036.8 filed on Nov. 29, 2023, in China National Intellectual Property Administration, the contents of which are incorporated by reference herein.

### FIELD

The subject matter herein generally relates to antenna technology field, and more particularly to an array antenna module and a wireless communication device.

### BACKGROUND

Low-orbit satellite system (LEO) is a large satellite system composed of multiple satellites that can process real-time information. The Low-orbit satellites are also used for communication with mobile terminals such as mobile phones, and due to the low orbital altitude, mobile terminals using low-orbit satellite communications have the advantages of short transmission delay and small path loss. A mobile communication system composed of multiple low-orbit satellites can achieve true global coverage and more effective frequency reuse. Technologies such as cellular communications, multiple access, spot beams, and frequency reuse also provide technical support for the application of low-orbit satellites in mobile communications. In summary, low-orbit satellites are currently a highly promising mobile communication system.

However, in order to reduce an overall area of the antenna design, the existing array antenna modules used in low-orbit satellites have a close arrangement between the transmitting antenna and the receiving antenna. For example, when the distance is less than 0.7 wavelength of the antenna operating frequency band, it is easy to cause mutual coupling interference problems, which may lead to a series of problems such as reduced antenna performance, limited bandwidth, and reduced efficiency, which is not conducive to the application of array antenna modules in mobile terminals. When the distance between the transmitting antenna and the receiving antenna is too close, for example, when the distance is less than 0.1 wavelength of the antenna operating frequency band, serious mutual coupling interference problems are likely to occur between the antennas, which may cause each antenna in the array antenna to be unable to operate independently and have difficulty maintaining stable performance.

### BRIEF DESCRIPTION OF THE DRAWINGS

Implementations of the present disclosure will now be described, by way of embodiments, with reference to the attached figures.

FIG. 1 is a schematic diagram of a unit of array antenna module according to a first embodiment of the present application.

FIG. 2 is a schematic diagram of a unit of array antenna module according to a second embodiment of the present application.

FIG. 3 is a schematic diagram of a unit of array antenna module according to a third embodiment of the present application.

FIG. 4 is a cross-sectional view of the unit of array antenna module according to an embodiment of the present application.

FIG. 5 is a schematic diagram of the array antenna module according to an embodiment of the present application.

FIG. 6 is a schematic diagram of the array antenna module according to another embodiment of the present application.

FIGS. 7A-7D are schematic diagrams of corresponding electric field distribution in different operating modes of the unit of array antenna module according to the embodiment of the present application.

FIGS. 8A-8B are schematic curve diagrams of corresponding return loss and isolation when the array antenna module according to the embodiment of the present application is provided with or without decoupling elements.

FIGS. 9A-9B are schematic curve diagrams of corresponding radiation gain when the array antenna module according to the embodiment of the present application is provided with or without the decoupling elements.

FIG. 10 is a schematic curve diagram of corresponding isolation when the unit of array antenna module according to the embodiment of the present application is provided with different decoupling elements.

FIGS. 11A-11D are schematic diagrams of the unit of array antenna module provided with decoupling elements with different structures according to the embodiment of the present application.

FIGS. 12A-12B are schematic curve diagrams of corresponding isolation when the unit of array antenna module according to the embodiment of the present application is provided with decoupling elements with different structures.

FIG. 13 is a schematic curve diagram of corresponding isolation when the unit of array antenna module according to the embodiment of the present application is provided with decoupling elements with different lengths.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

Low-orbit satellite system (LEO) is a large satellite system composed of multiple satellites that can process real-time information. The Low-orbit satellites are also used for communication with mobile terminals such as mobile phones, and due to the low orbital altitude, mobile terminals using low-orbit satellite communications have the advantages of short transmission delay and small path loss. A mobile communication system composed of multiple low-orbit satellites can achieve true global coverage and more effective frequency reuse. Technologies such as cellular communications, multiple access, spot beams, and frequency reuse also provide technical support for the application of low-orbit satellites in mobile communications. In summary, low-orbit satellites are currently a highly promising mobile communication system.

However, in order to reduce an overall area of the antenna design, the existing array antenna modules used in low-orbit satellites have a close arrangement between the transmitting antenna and the receiving antenna, which is easy to cause mutual coupling interference problems, which may lead to a series of problems such as reduced antenna performance, limited bandwidth, and reduced efficiency, which is not conducive to the application of array antenna modules in mobile terminals.

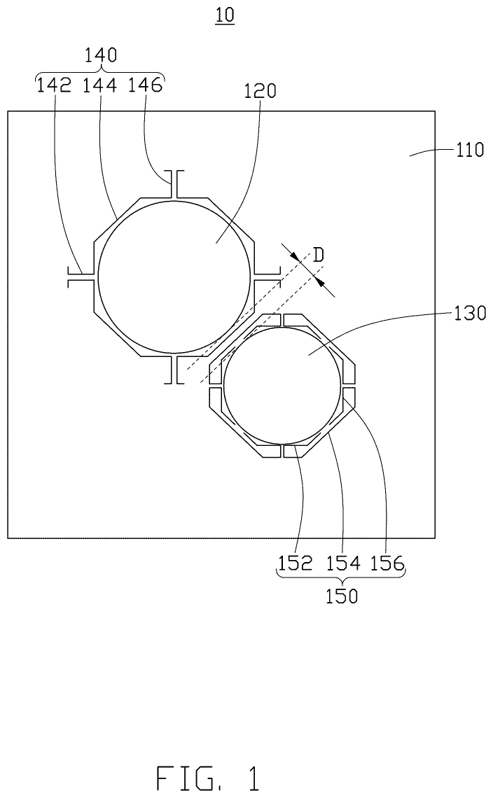

Referring to FIG. 1, the present application provides a unit 10 of array antenna module 1, which can be applied in a wireless communication device (not shown in the figures), to realize wireless communication of the wireless communication device based on low-orbit satellites. The array antenna module 1 is used to transmit or receive wireless signals to achieve wireless communication.

Referring to FIG. 1 again, in some embodiments of the present application, the unit 10 of array antenna module 1 includes a dielectric substrate 110, at least one transmitting antenna 130, at least one receiving antenna 120, at least one first decoupling element 150, and at least one second decoupling element 140.

The at least one transmitting antenna 130 and the at least one receiving antenna 120 are disposed adjacent to each other and are disposed on the dielectric substrate 110. The at least one transmitting antenna 130 is used for transmitting wireless signals and has a first operating frequency band. The at least one receiving antenna 120 is used for receiving wireless signals and has a second operating frequency band. In some embodiments, since the at least one transmitting antenna 130 and the at least one receiving antenna 120 are disposed adjacent to each other at a relatively close distance, mutual coupling interferences may occur when the at least one transmitting antenna 130 and the at least one receiving antenna 120 are operating.

The at least one first decoupling element 150 and the at least one second decoupling element 140 are disposed on the dielectric substrate 110. The at least one first decoupling element 150 is disposed between the at least one transmitting antenna 130 and the at least one receiving antenna 120 and closes to the at least one transmitting antenna 130. The at least one second decoupling element 140 is disposed between the at least one transmitting antenna 130 and the at least one receiving antenna 120 and closes to the at least one receiving antenna 120. The at least one first decoupling element 150 and the at least one second decoupling element 140 are spaced apart from each other.

In some embodiments, the at least one first decoupling element 150 and the at least one second decoupling element 140 may be metal pieces. The at least one first decoupling element 150 and the at least one second decoupling element 140 are arranged between the at least one transmitting antenna 130 and the at least one receiving antenna 120, which can isolate surface current between antennas and achieve decoupling effect.

In some embodiments, a distance D between the at least one transmitting antenna 130 and the at least one receiving antenna 120 can be, but is not limited to, 1 millimeter (mm), the at least one transmitting antenna 130 and the at least one receiving antenna 120 may easy to cause mutual coupling interference problems. In some embodiments, the distance D between the at least one transmitting antenna 130 and the at least one receiving antenna 120 is less than 0.7 wavelength of operating bands thereof, the at least one transmitting antenna 130 and the at least one receiving antenna 120 may easy to cause mutual coupling interference problems. In other embodiments, the distance D between the at least one transmitting antenna 130 and the at least one receiving antenna 120 is less than 0.1 wavelength of operating bands thereof, the at least one transmitting antenna 130 and the at least one receiving antenna 120 may easy to cause serious mutual coupling interference problems. For instance, a length of the at least one first decoupling element 150 may be 0.7-0.8 wavelength, 0.8-0.9 wavelength, 0.9-1.0 wavelength, 1.0-1.1 wavelength, 1.1-1.2 wavelength, or 0.7-1.2 wavelength of the operating band (that is a first operating band) of the at least one transmitting antenna 130, preferably 0.9-1.0 wavelength of the operating band (that is the first operating band) of the at least one transmitting antenna 130. A length of the at least one second decoupling element 140 may be 0.7-0.8 wavelength, 0.8-0.9 wavelength, 0.9-1.0 wavelength, 1.0-1.1 wavelength, 1.1-1.2 wavelength, or 0.7-1.2 wavelength of the operating band (that is a second operating band) of the at least one receiving antenna 120, preferably 0.9-1.0 wavelength of the operating band (that is the second operating band) of the at least one receiving antenna 120. There is a first separation distance between the at least one first decoupling element 150 and the at least one transmitting antenna 130, the first separation distance may be 0.1-0.5 millimeters (mm). There is a second separation distance between the at least one second decoupling element 140 and the at least one receiving antenna 120, the second separation distance may be 0.1-0.5 millimeters (mm).

Referring to FIG. 1 again, FIG. 1 illustrates the unit 10 of array antenna module 1 according to a first embodiment, the unit 10 of array antenna module 1 includes a dielectric substrate 110, a transmitting antenna 130, a receiving antenna 120, four first decoupling elements 150, and four second decoupling elements 140. It can be understood that an array antenna module can be combined by a plurality of units 10 of array antenna module 1 as shown in FIG. 1.

The four second decoupling elements 140 are arranged from end to end at intervals and surround the receiving antenna 120. In some embodiments, the receiving antenna 120 is substantially circular, and the four second decoupling elements 140 are spaced apart along a circumferential direction of the receiving antenna 120 to surround an outer periphery of the receiving antenna 120. In some embodiments, each of the four second decoupling elements 140 includes a first section 142, a second section 144, and a third section 146 connected in that order. Structures of the first section 142 and the third section 146 are substantially the same, and the first section 142 and the third section 146 are symmetrically connected to opposite ends of the second section 144. The second section 144 is spaced apart along the edge of the receiving antenna 120. In some embodiments, the second section 144 is substantially U-shaped, and an angle between two end arms and a middle arm is an obtuse angle, so that the second section 144 fits an arc edge of the receiving antenna 120. The first section 142 and the third section 146 respectively extend from the edge adjacent to the receiving antenna 120 in a direction away from the edge of the receiving antenna 120, that is, extend outward from the edge adjacent to the receiving antenna 120. In some embodiments, the first section 142 and the third section 146 are each substantially L-shaped. One end of each of the first section 142 and the third section 146 is connected to the ends of the second section 144 at a position adjacent to the edge of the receiving antenna 120, and the other end extends outward and bends towards each other. In some embodiments, the third section 146 is disposed opposite the first section 142 of the adjacent first decoupling element 150.

The four first decoupling elements 150 are arranged from end to end at intervals and surround the transmitting antenna 130. In some embodiments, the transmitting antenna 130 is substantially circular, and the four first decoupling elements 150 are spaced apart along a circumferential direction of the transmitting antenna 130 to surround an outer periphery of the transmitting antenna 130. In some embodiments, each of the four first decoupling elements 150 includes a fourth section 152, a fifth section 154, and a sixth section 156 connected in that order. Structures of the fourth section 152 and the sixth section 156 are substantially the same, and the fourth section 152 and the sixth section 156 are symmetrically connected to opposite ends of the fifth section 154. The fifth section 154 is spaced apart along the edge of the transmitting antenna 130. In some embodiments, the fifth section 154 is substantially U-shaped, and an angle between two end arms and a middle arm is an obtuse angle, so that the fifth section 154 fits an arc edge of the transmitting antenna 130. The fourth section 152 and the sixth section 156 respectively extend from the edge adjacent to the transmitting antenna 130 towards closer to the edge of the transmitting antenna 130, that is, extend inward from the edge adjacent to the transmitting antenna 130. In some embodiments, the fourth section 152 and the sixth section 156 are each substantially in a shape of a multi-section bend. One end of each of the fourth section 152 and the sixth section 156 is respectively connected to the end of the fourth section 152 at a position adjacent to the edge of the transmitting antenna 130, and the other end extends inward and then bends toward each other. In some embodiments, the sixth section 156 is disposed opposite the fourth section 152 of the adjacent second decoupling element 140.

In other embodiments, the transmitting antenna 130 and the receiving antenna 120 may also be in other structures or shapes, such as rectangle, triangle, ellipse, quadrilateral, etc. It can be understood that the structures of the transmitting antenna 130, the receiving antenna 120, the first decoupling element 150 and the second decoupling element 140 in this application are only exemplary descriptions. In some other embodiments, these structures can be constructed by those skilled in the art and can be adjusted and exchanged according to actual needs, and this application does not impose any restrictions here. For instance, the structures of the transmitting antenna 130 and the receiving antenna 120 are exchanged, and the structures of the first decoupling element 150 and the second decoupling element 140 are also exchanged.

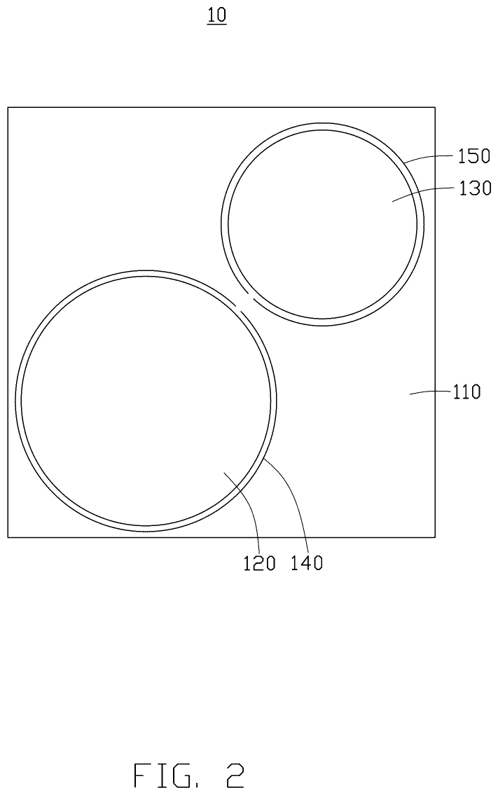

Referring to FIG. 2, FIG. 2 illustrates a unit 10 of array antenna module 1 according to a second embodiment, the unit 10 of array antenna module 1 includes a dielectric substrate 110, a transmitting antenna 130, a receiving antenna 120, a first decoupling element 150, and a second decoupling element 140. It can be understood that an array antenna module can be combined by a plurality of units 10 of array antenna module 1 as shown in FIG. 2. It can be implemented in a specific setting environment, where the distance between the transmitting antenna 130 and the receiving antenna 120 is approximately 1 mm, a first spacing distance between the first decoupling element 150 and the transmitting antenna 130 is 0.1 to 0.5 mm, and a second spacing distance between the second decoupling element 140 and the receiving antenna 120 is 0.1 to 0.5 mm.

The first decoupling element 150 surrounds the transmitting antenna 130. In some embodiments, the transmitting antenna 130 is substantially circular, the first decoupling element 150 is substantially circular, and is arranged at intervals along the circumferential direction of the transmitting antenna 130 to surround the outer edge of the transmitting antenna 130.

The second decoupling element 140 surrounds the receiving antenna 120. In some embodiments, the receiving antenna 120 is substantially circular, the second decoupling element 140 is substantially circular, and is arranged at intervals along the circumferential direction of the receiving antenna 120 to surround the outer edge of the receiving antenna 120. It can be understood that when the transmitting antenna 130 and the receiving antenna 120 can also be in other shapes, such as a rectangle, a triangle, an ellipse, a quadrilateral, etc., the first decoupling element 150 and the second decoupling element 140 can also be in shapes corresponding to the transmitting antenna 130 and the receiving antenna 120, respectively, and are respectively arranged along the outer contours of the transmitting antenna 130 and the receiving antenna 120.

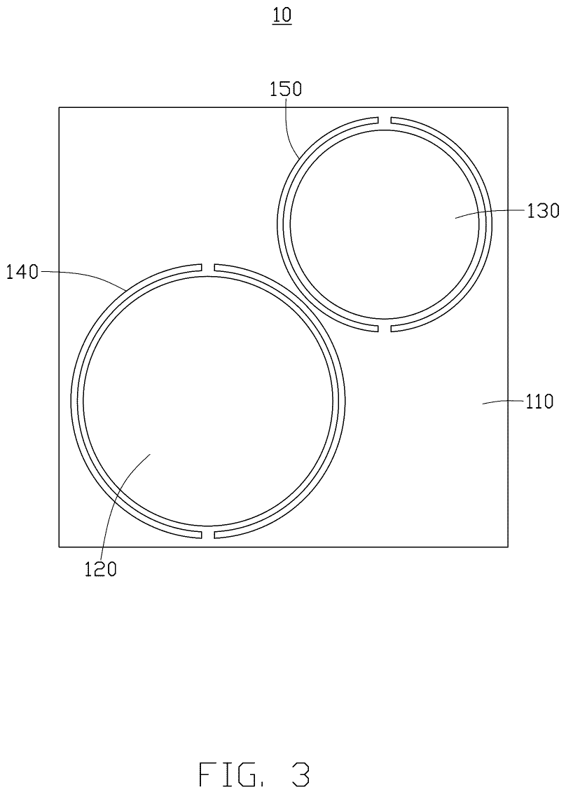

Referring to FIG. 3, FIG. 3 illustrates a unit 10 of array antenna module 1 according to a third embodiment, the unit 10 of array antenna module 1 includes a dielectric substrate 110, a transmitting antenna 130, a receiving antenna 120, two first decoupling elements 150, and two second decoupling elements 140. It can be understood that the array antenna module 1 shown in FIG. 3 can be implemented in a specific setting environment and can be combined by a plurality of the units 10 of array antenna module 1 as shown in FIG. 3, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm.

The two first decoupling elements 150 are arranged alternately end to end and surround the transmitting antenna 130. In some embodiments, the transmitting antenna 130 is substantially circular, each of the first decoupling elements 150 is substantially semicircular, and the two first decoupling elements 150 are arranged at intervals along the circumferential direction of the transmitting antenna 130 to surround an outer periphery of the transmitting antenna 130.

In some embodiments, interval positions of the two first decoupling elements 150 are equally spaced along the circumferential direction of the transmitting antenna 130. In some embodiments, the interval positions of the two first decoupling elements 150 are spaced every 180 degrees along the circumferential direction of the transmitting antenna 130.

The two second decoupling elements 140 are arranged alternately end to end and surround the receiving antenna 120. In some embodiments, the receiving antenna 120 is substantially circular, each of the second decoupling elements 140 is substantially semicircular, and the two second decoupling elements 140 are arranged at intervals along the circumferential direction of the receiving antenna 120 to surround an outer periphery of the receiving antenna 120.

In some embodiments, interval positions of the two second decoupling elements 140 are equally spaced along the circumferential direction of the receiving antenna 120. In some embodiments, the interval positions of the two second decoupling elements 140 are spaced every 180 degrees along the circumferential direction of the receiving antenna 120.

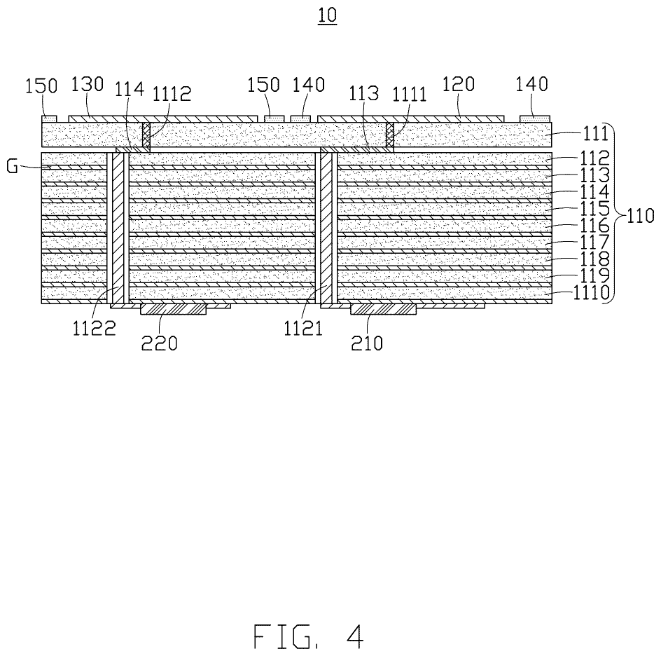

Referring to FIG. 4, FIG. 4 is a cross-sectional view of the unit 10 of array antenna module 1 according to an embodiment of the present application. It can be understood that the array antenna module 1 can be combined by a plurality of the units 10 of array antenna module 1 as shown in FIG. 4, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. In some embodiments, the transmitting antenna 130 and the receiving antenna 120 are both fed with current by direct feeding. For example, in some embodiments, the dielectric substrate 110 may be a multi-layer dielectric substrate, including N layers of substrates, where N is a positive integer greater than or equal to 2, that is, the dielectric substrate 110 may include a first substrate, . . . , an N^{th} substrate. In the embodiment, the dielectric substrate 110 includes a first substrate 111, a second substrate 112, a third substrate 113, a fourth substrate 114, a fifth substrate 115, a sixth substrate 116, a seventh substrate 117, an eighth substrate 118, a ninth substrate 119, and a tenth substrate 1110 arranged in stack. A surface of the first substrate 111 away from the second substrate 112 is provided with the transmitting antenna 130, the receiving antenna 120, the first decoupling element 150, and the second decoupling element 140. A surface of the second substrate 112 away from the first substrate 111 is provided with a grounding layer G for providing grounding for the transmitting antenna 130 and the receiving antenna 120. The first substrate 111 is further provided with a first via hole 1111 and a second via hole 1112. A first feed line 113 and a second feed line 114 are further provided between the first substrate 111 and the second substrate 112. Thus, the first feed line 113 can feed current to the corresponding receiving antenna 120 through the first via hole 1111, so that the receiving antenna 120 excites a corresponding radiation signal. The second feed line 114 can feed current to the corresponding transmitting antenna 130 through the second via hole 1112, so that the transmitting antenna 130 excites a corresponding radiation signal.

In some embodiments, a ground layer G is provided on a surface of each substrate from the second substrate 112 to the tenth substrate 1110 away from the first substrate 111. The unit 10 of array antenna module 1 further includes a radio frequency (RF) transmitting front-end module 220 and a radio frequency (RF) receiving front-end module 210. The radio frequency transmitting front-end module 220 and the radio frequency receiving front-end module 210 are respectively provided on a surface of the first substrate 111 farthest from the tenth substrate 1110. The second substrate 112 to the tenth substrate 1110 are further provided with a third via hole 1121 and a fourth via hole 1122. In this way, the RF receiving front-end module 210 can be connected to the first feed line 113 through the third via hole 1121, and then connected to the receiving antenna 120 through the first via hole 1111, so that the RF receiving front-end module 210 can control the receiving antenna 120. The RF transmitting front-end module 220 can be connected to the second feed line 114 through the fourth via hole 1122, and then connected to the transmitting antenna 130 through the second via hole 1112, so that the RF transmitting front-end module 220 can control the transmitting antenna 130. In some embodiments, the third via hole 1121 and the fourth via hole 1122 pass through the second substrate 112 to the tenth substrate 1110 respectively.

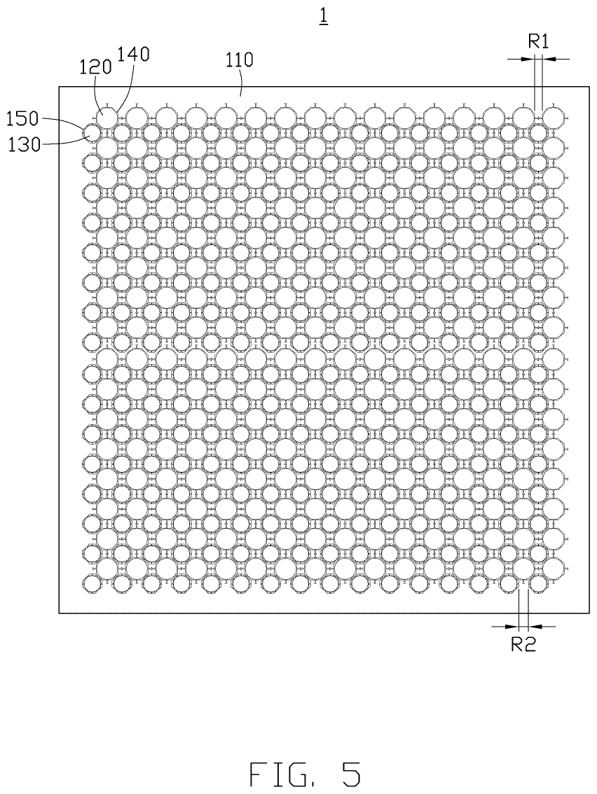

Referring to FIG. 5, FIG. 5 is a schematic diagram of the array antenna module 1 according to an embodiment of the present application. It can be understood that the array antenna module 1 including a plurality of the units 10 of array antenna module 1 as shown in FIGS. 1 to 4 can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. The difference between the array antenna module 1 of the embodiment shown in FIG. 5 and the array antenna module 1 of the embodiment shown in FIG. 1 is that: the array antenna module 1 of FIG. 1 includes a group of transmitting antenna 130 and receiving antenna 120, and a corresponding group of first decoupling element 150 and second decoupling element 140; the array antenna module 1 of FIG. 5 includes multiple groups of transmitting antenna 130 and receiving antenna 120, and corresponding multiple groups of first decoupling element 150 and second decoupling element 140 for forming an array antenna.

Referring to FIG. 5, the array antenna module 1 includes a plurality of the transmitting antennas 130 arranged in rows and a plurality of the receiving antennas 120 arranged in rows. In each row of receiving antennas 120, every two adjacent receiving antennas 120 are spaced apart by a first predetermined distance R1. In each row of transmitting antennas 130, every two adjacent transmitting antennas 130 are spaced apart by a second predetermined distance R2. And each receiving antenna 120 is disposed staggered between two transmitting antennas 130. It can be understood that this application does not limit the size of the first predetermined distance R1 and the second predetermined distance R2. For example, in one embodiment of the present application, the first predetermined distance R1 may be greater than the second predetermined distance R2; in another embodiment of the present application, the first predetermined distance R1 may be less than or equal to the second predetermined distance R2. Those skilled in the art can make corresponding adjustments to the size of the first predetermined distance R1 and the size of the second predetermined distance R2 according to product size design or radiation frequency adjustment requirements.

The plurality of rows of transmitting antennas 130 and the plurality of rows of receiving antennas 120 are disposed in offset positions to form an array disposed on the dielectric substrate 110. That is to say, in some embodiments, each row of transmitting antennas 130 and each row of receiving antennas 120 are alternately disposed on the dielectric substrate 110. Thus, in the embodiment of the present application, the transmitting antennas 130 and the receiving antennas 120 are mixed and staggered in the same area on the dielectric substrate 110, which can reduce the area of the dielectric substrate 110 and is conducive to the miniaturization design of the array antenna module 1.

The array antenna module 1 further includes a plurality of first decoupling elements 150 and a plurality of second decoupling elements 140. A quantity of the first decoupling elements 150 corresponds to a quantity of the transmitting antennas 130, and a quantity of the second decoupling elements 140 corresponds to a quantity of the receiving antennas 120. Each transmit antenna 130 is surrounded by a corresponding first decoupling element 150, and each receive antenna 120 is surrounded by a corresponding second decoupling element 140. It can be understood that the first decoupling element 150 and the second decoupling element 140 can be a single, two, or four combinations surrounding the transmitting antenna 130 and the receiving antenna 120 disclosed in the above embodiments, which will not be described again here.

It can be understood that this application does not specifically limit the shapes and areas of the transmitting antenna 130 and the receiving antenna 120, and those skilled in the art can make adjustments as needed. In some embodiments, the area of the transmit antenna 130 is smaller than the area of the receive antenna 120. The area of the transmitting antenna 130 is smaller than the area of the receiving antenna 120, so that the transmitting antenna 130 can transmit a radiation signal with a higher frequency than the receiving antenna 120. In another embodiment of the present application, the area of the transmitting antenna 130 may be larger than the area of the receiving antenna 120. The area of the transmitting antenna 130 is larger than the area of the receiving antenna 120, so that the transmitting antenna 130 can transmit a radiation signal with a lower frequency than that of the receiving antenna 120. In another embodiment of the present application, the area of the transmitting antenna 130 may be equal to the area of the receiving antenna 120. The area of the transmitting antenna 130 is equal to the area of the receiving antenna 120, so that the transmitting antenna 130 can transmit radiation signals of the same frequency as the receiving antenna 120. And the transmitting antenna 130 and the receiving antenna 120 can also be conductors in other shapes, such as ellipse, rectangle, etc.

It can be understood that this application does not limit the size of the first predetermined distance R1 and the second predetermined distance R2. In some embodiments, the first predetermined distance R1 and the second predetermined distance R2 may be equal or unequal.

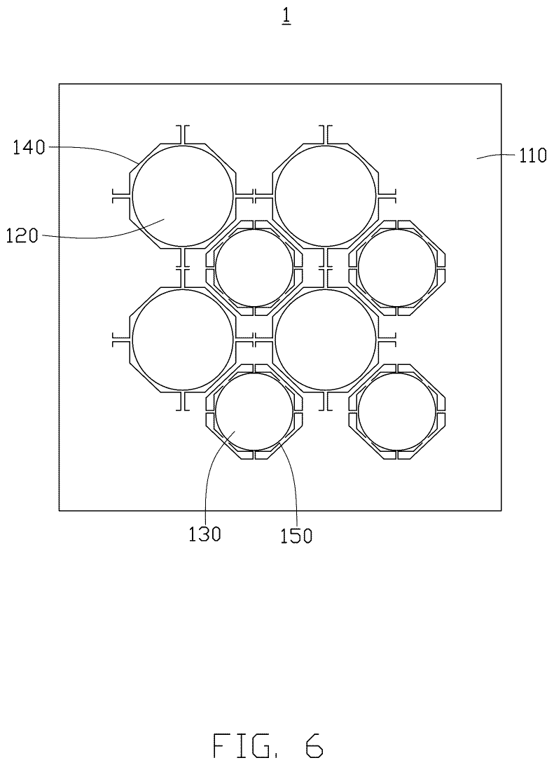

Referring to FIGS. 5 and 6, the array antenna module 1 shown in FIG. 5 includes 32*32 transmitting antennas 130 and 32*32 receiving antennas 120. The array antenna module 1 shown in FIG. 6 includes 2*2 transmitting antennas 130 and 2*2 receiving antennas 120. It can be understood that those skilled in the art can set and adjust the array antenna module 1 according to actual needs, such as a 4*4 or 32*32 transmitting antennas 130 and 4*4 or 32*32 receiving antennas 120, etc. This will not be repeated here. It can be understood that the array antenna module 1 shown in FIGS. 5 and 6 can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm.

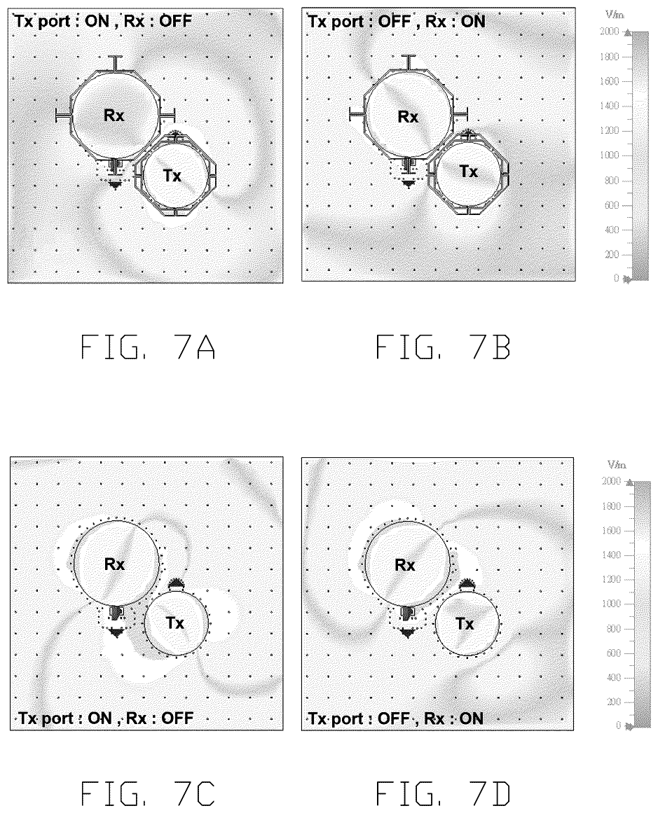

Referring to FIGS. 7A to 7D, FIGS. 7A to 7D are schematic diagrams of corresponding electric field distribution in different operating modes of the unit 10 of array antenna module 1 according to the embodiment of the present application. FIG. 7A shows the electric field distribution when the transmitting antenna 130 and the receiving antenna 120 are respectively surrounded by the first decoupling element 150 and the second decoupling element 140, the transmitting antenna 130 is turned on and the receiving antenna 120 is turned off. FIG. 7B shows the electric field distribution when the transmitting antenna 130 and the receiving antenna 120 are respectively surrounded by the first decoupling element 150 and the second decoupling element 140, the transmitting antenna 130 is turned off and the receiving antenna 120 is turned on. FIG. 7C shows the electric field distribution when the transmitting antenna 130 and the receiving antenna 120 do not surrounded by the first decoupling element 150 and the second decoupling element 140, the transmitting antenna 130 is turned on and the receiving antenna 120 is turned off. FIG. 7D shows the electric field distribution when the transmitting antenna 130 and the receiving antenna 120 do not surrounded by the first decoupling element 150 and the second decoupling element 140, the transmitting antenna 130 is turned off and the receiving antenna 120 is turned on. It can be concluded from the electric field distribution schematic diagrams of FIGS. 7A to 7D that when the first decoupling element 150 and the second decoupling element 140 are included, the electric field energy distribution is concentrated on the transmitting antenna 130 and the receiving antenna 120, and the mutual interference effect is minimal. When the first decoupling element 150 and the second decoupling element 140 are excluded, the electric field energy distributions of the transmitting antenna 130 and the receiving antenna 120 will couple to each other. It can be understood that the array antenna module 1 can be combined by a plurality of the units 10 of array antenna module 1 as shown in FIGS. 7A to 7D. The distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. More specifically, in FIGS. 7A to 7D, the first spacing distance between the first decoupling element 150 and the transmit antenna 130 is 0.1 mm, and the second spacing distance between the second decoupling element 140 and the receive antenna 120 is 0.1 mm.

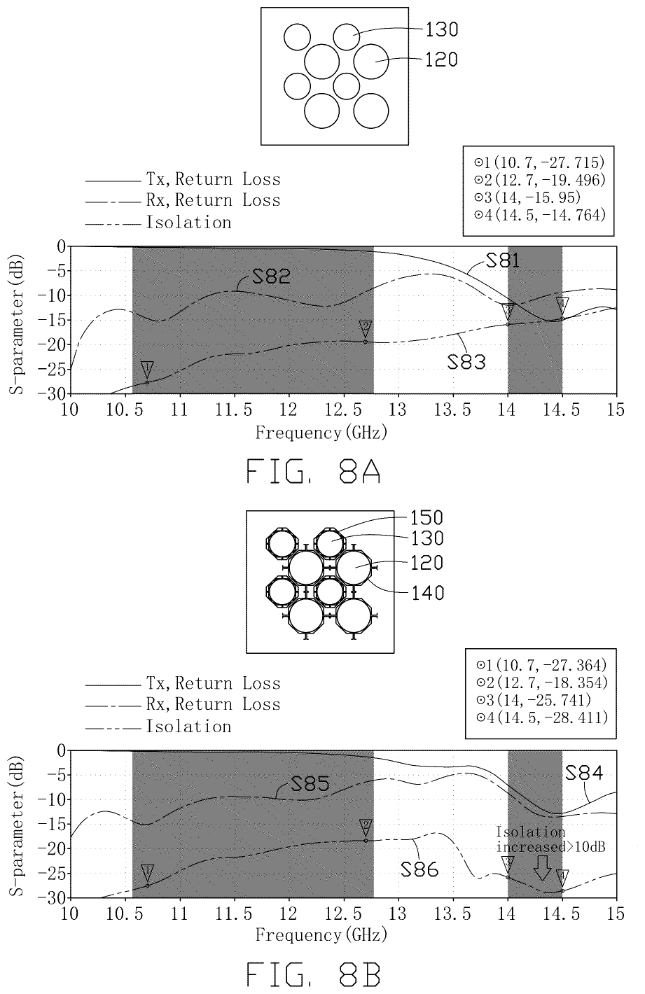

Referring to FIGS. 8A and 8B, FIGS. 8A and 8B are schematic curve diagrams of corresponding return loss and isolation when the array antenna module 1 according to the embodiment of the present application is provided with or without the decoupling elements. FIG. 8A shows the curves of scattering parameters (S-parameter) and isolation in predetermined operating frequency bands when the transmitting antenna 130 and the receiving antenna 120 do not surrounded by the first decoupling element 150 and the second decoupling element 140. Curve S81 is a S-parameter curve of the transmitting antenna 130, curve S82 is a S-parameter curve of the receiving antenna 120, and curve S83 is an isolation curve of the transmitting antenna 130 and the receiving antenna 120.

FIG. 8B shows the curves of scattering parameters (S-parameter) and isolation in predetermined operating frequency bands when the transmitting antenna 130 and the receiving antenna 120 are respectively surrounded by the first decoupling element 150 and the second decoupling element 140. Curve S84 is a S-parameter curve of the transmitting antenna 130, curve S85 is a S-parameter curve of the receiving antenna 120, and curve S86 is an isolation curve of the transmitting antenna 130 and the receiving antenna 120. It can be concluded from the isolation curve diagrams of FIGS. 8A and 8B that when the transmitting antenna 130 and the receiving antenna 120 are respectively surrounded by the first decoupling element 150 and the second decoupling element 140, and in the predetermined operating frequency band (for example, in the low-orbit satellite Ku Band transmitting frequency band (14.0 GHz-14.5 GHz), the isolation between the transmitting antenna 130 and the receiving antenna 120 is increased by approximately 10 decibels (dB). It can be understood that the array antenna module 1 shown in FIGS. 8A and 8B can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. More specifically, in FIGS. 8A to 8D, the first spacing distance between the first decoupling element 150 and the transmit antenna 130 is 0.1 mm, and the second spacing distance between the second decoupling element 140 and the receive antenna 120 is 0.1 mm.

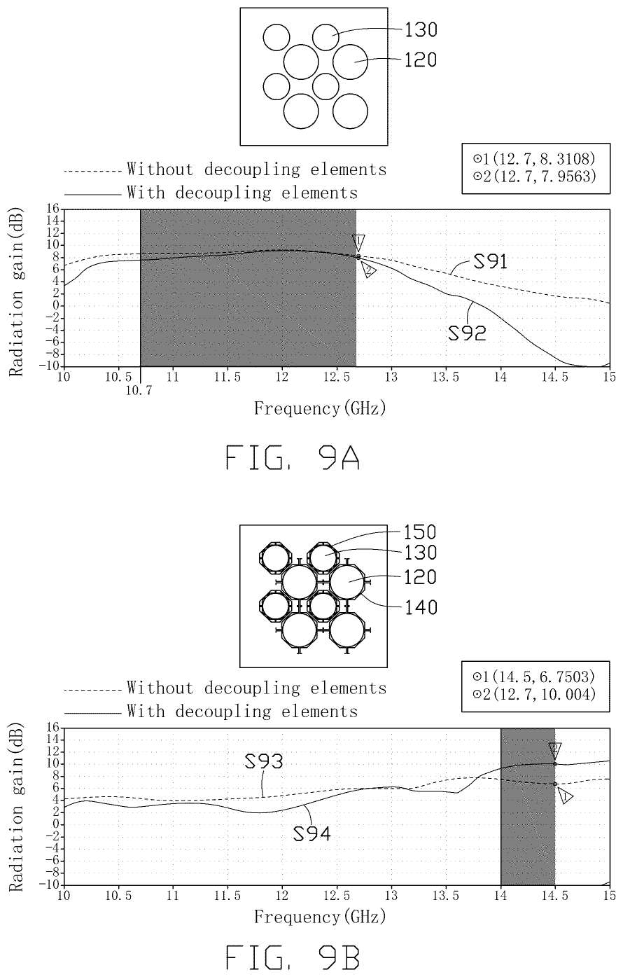

Referring to FIGS. 9A and 9B, FIGS. 9A-9B are schematic curve diagrams of corresponding radiation gain when the array antenna module 1 according to the embodiment of the present application is provided with or without the decoupling elements. FIG. 9A is a schematic curve diagram of the radiation gain corresponding to the predetermined receiving frequency band when the array antenna module 1 provided by the embodiment of the present application is provided with the decoupling elements or not. Curve S91 is a curve corresponding to the radiation gain of the receiving antenna 120 in the predetermined receiving frequency band (such as the low-orbit satellite Ku Band receiving frequency band, 10.7 GHz-12.7 GHz) when the first decoupling element 150 and the second decoupling element 140 are not included. Curve S92 is a curve corresponding to the radiation gain of the receiving antenna 120 in the predetermined receiving frequency band (such as the low-orbit satellite Ku Band receiving frequency band, 10.7 GHz-12.7 GHz) when the transmitting antenna 130 and the receiving antenna 120 are respectively surrounded by the first decoupling element 150 and the second decoupling element 140. FIG. 9B is a schematic diagram of the radiation gain corresponding to the predetermined receiving frequency band when the array antenna module 1 provided by the embodiment of the present application is provided with the decoupling elements or not. Curve S93 is a curve of the radiation gain corresponding to the transmitting antenna 130 in the predetermined transmitting frequency band (such as the low-orbit satellite Ku Band transmitting frequency band, 14.0 GHz-14.5 GHz) when the first decoupling element 150 and the second decoupling element 140 are not included. Curve S94 is a curve of the radiation gain corresponding to the transmitting antenna 130 in the predetermined transmitting frequency band (such as the low-orbit satellite Ku Band transmitting frequency band, 14.0 GHz-14.5 GHz) when the transmitting antenna 130 and the receiving antenna 120 are respectively surrounded by the first decoupling element 150 and the second decoupling element 140. It can be concluded from the schematic diagrams of the radiation gain curves of FIGS. 9A and 9B that when the transmitting antenna 130 and the receiving antenna 120 are respectively surrounded by the first decoupling element 150 and the second decoupling element 140, and in the predetermined operating frequency band (for example, the low-orbiting satellite Ku Band transmitting frequency band, 14.0 GHz-14.5 GHz), the radiation gain of the transmitting antenna 130 is increased by approximately 2-3 decibels (dB), while in the predetermined operating frequency band (such as the low-orbiting satellite Ku Band receiving frequency band, 10.7 GHz-12.7 GHz), the radiation gain of the receiving antenna 120 has a slight impact. It can be understood that the array antenna module 1 shown in FIGS. 9A and 9B can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. More specifically, in FIGS. 9A to 9D, the first spacing distance between the first decoupling element 150 and the transmit antenna 130 is 0.1 mm, and the second spacing distance between the second decoupling element 140 and the receive antenna 120 is 0.1 mm.

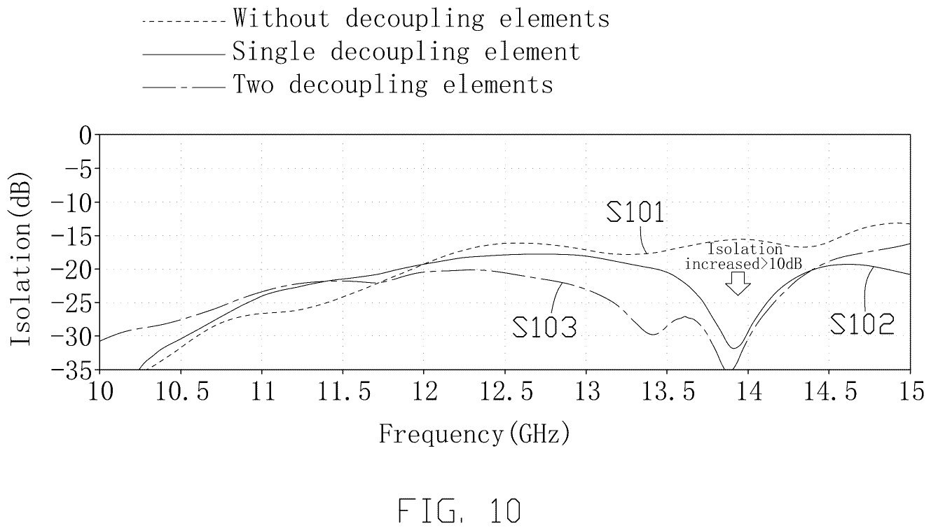

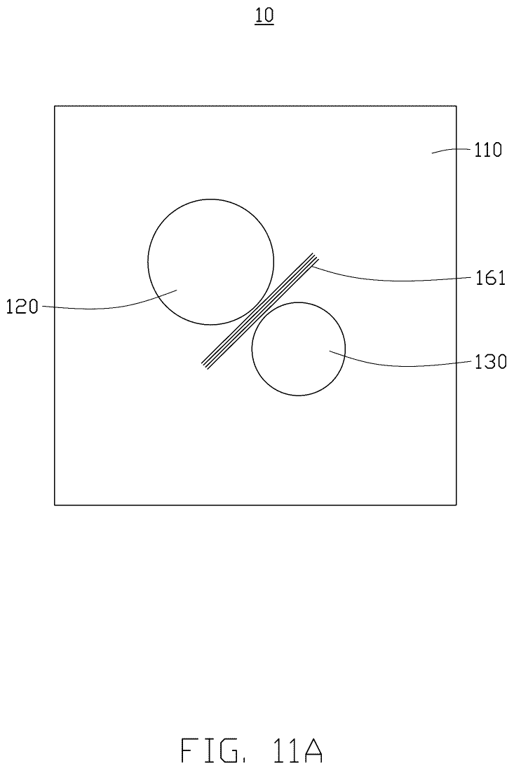

FIG. 10 is a schematic curve diagram of corresponding isolation when the unit 10 of array antenna module 1 according to the embodiment of the present application is provided with different decoupling elements. Curve S101 is an isolation curve when the transmitting antenna 130 and the receiving antenna 120 are not surrounded by the first decoupling element 150 and the second decoupling element 140. Curve S102 is an isolation curve when the transmitting antenna 130 and the receiving antenna 120 shown in FIG. 2 are respectively surrounded by one decoupling element or single decoupling element. Curve S103 is an isolation curve when the transmitting antenna 130 and the receiving antenna 120 shown in FIG. 3 are respectively surrounded by two decoupling elements. If the first decoupling element 150 is provided, the first spacing distance between the first decoupling element 150 and the transmitting antenna 130 is 0.1 to 0.5 millimeters; if the second decoupling element 140 is provided, the second spacing distance between the second decoupling element 140 and the receiving antenna 120 is 0.1 to 0.5 millimeters. It can be seen from the schematic diagram of the isolation curves in FIG. 10 that arranging one or more decoupling elements around the transmitting antenna 130 and the receiving antenna 120 can achieve a certain decoupling effect between the transmitting antenna 130 and the receiving antenna 120.

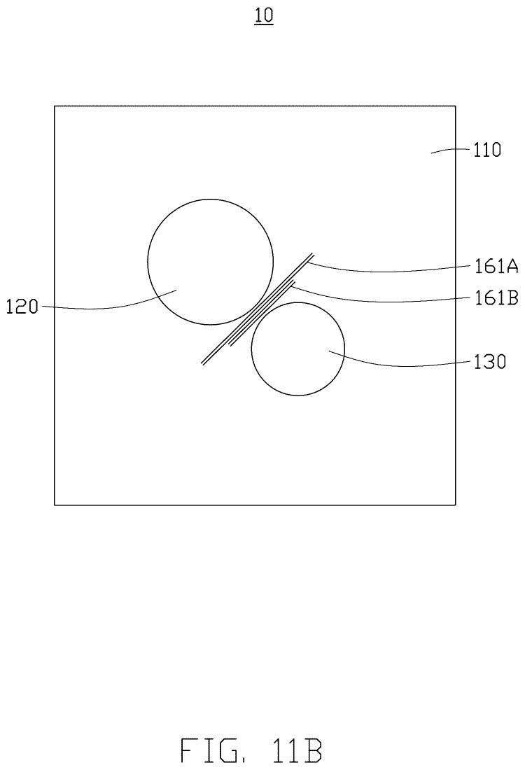

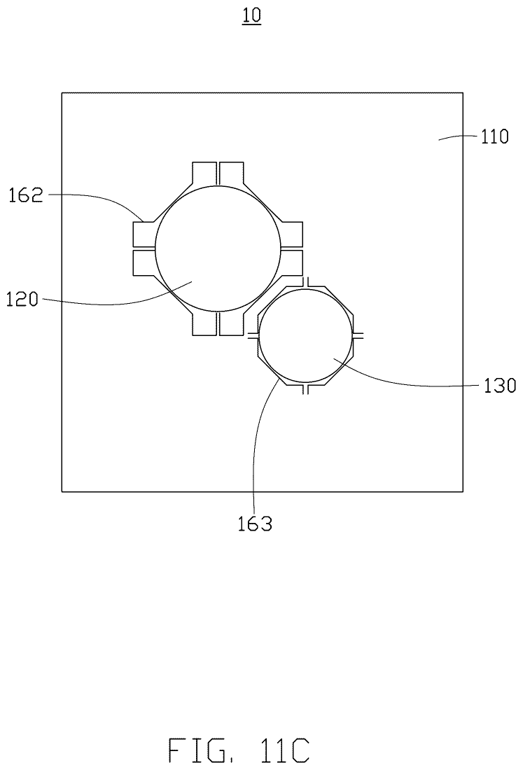

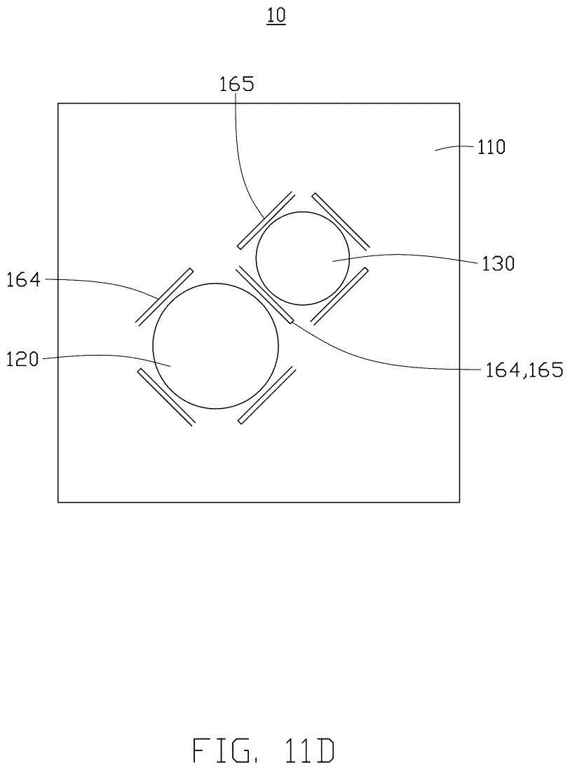

FIGS. 11A to 11D are schematic diagrams of the unit 10 of array antenna module 1 provided with decoupling elements with different structures according to the embodiment of the present application. Referring to FIGS. 11A and 11B, decoupling element 161 is disposed between the transmitting antenna 130 and the receiving antenna 120. FIG. 11A shows a single decoupling element 161, and FIG. 11B shows decoupling elements 161A and 161B arranged at intervals. In some embodiments, decoupling elements 161A and 161B are respectively substantially in a shape of rectangular metal sections of different lengths, the decoupling element 161A can be the second decoupling element, disposed closer to the receiving antenna 120, and a length of the decoupling element 161A is 0.9 to 1.0 wavelength of the operating frequency band (for example, the second operating frequency band) wavelength of the receiving antenna 120, and has a relatively longer length in the embodiment of FIG. 11B. The decoupling element 161B can be the first decoupling element, disposed closer to the transmitting antenna 130, and a length of the decoupling element 161B is 0.9 to 1.0 wavelength of the operating frequency band (for example, the first operating frequency band) of the transmitting antenna 130, and has a relatively shorter length in the embodiment of FIG. 11B. Referring to FIG. 11C, the receiving antenna 120 is surrounded by a second decoupling element 162, the transmitting antenna 130 is surrounded by a first decoupling element 163. In some embodiments, a structure of the second decoupling element 162 is substantially similar to a structure of the first decoupling element 150 shown in FIG. 1, and a structure of the first decoupling element 163 is substantially similar to the structure of the second decoupling element 140 shown in FIG. 1, that is, the structures of the second decoupling element 162 and the first decoupling element 163 shown in FIG. 11C are interchanged with the structures of the first decoupling element 150 and the second decoupling element 140 shown in FIG. 1. Referring to FIG. 11D, the transmitting antenna 130 is surrounded by a first decoupling element 165 and the receiving antenna 120 is surrounded by a second decoupling element 164. In some embodiments, the first decoupling element 165 and the second decoupling element 164 are substantially composed of four rectangular metal plates, which are spaced apart along the periphery of the transmitting antenna 130 and the receiving antenna 120 respectively. It can be understood that the first decoupling element 165 or the second decoupling element 164 is positioned between the transmitting antenna 130 and the receiving antenna 120. It can be understood that an array antenna module 1 can be combined by a plurality of the units 10 of array antenna module 1 as shown in FIGS. 11A to 11D. It can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm.

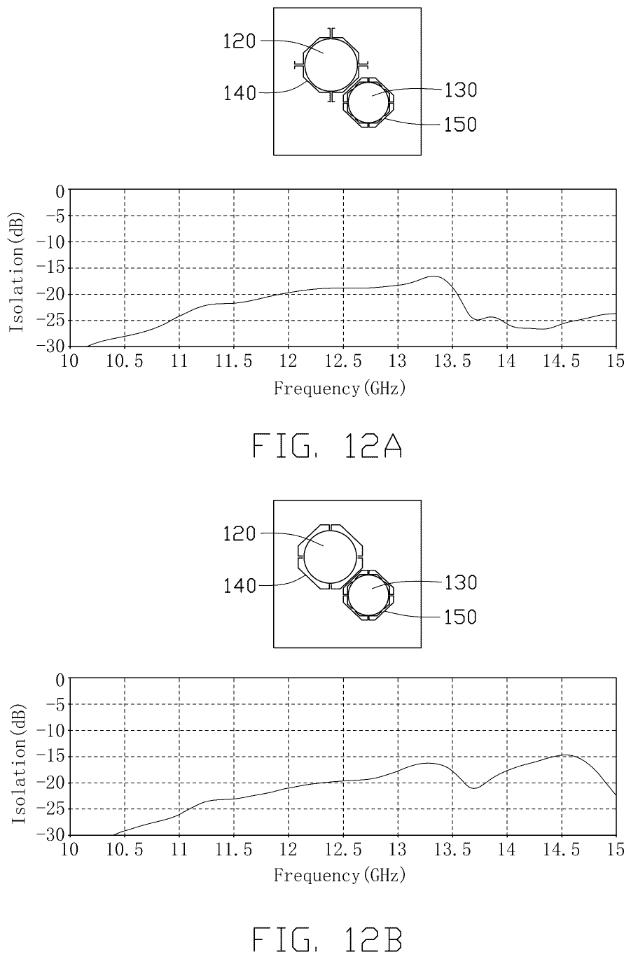

FIGS. 12A and 12B are schematic curve diagrams of corresponding isolation when the unit 10 of array antenna module 1 according to the embodiment of the present application is provided with decoupling elements with different structures. FIG. 12A shows the isolation between the transmitting antenna 130 and the receiving antenna 120 when the unit 10 of array antenna module 1 is provided with the first decoupling element 150 and the second decoupling element 140 as shown in FIG. 1. The isolation can be less than −20 dB. FIG. 12B shows the isolation between the transmitting antenna 130 and the receiving antenna 120 when the unit 10 of array antenna module 1 is provided with the first decoupling element 150 and the second decoupling element 140 as shown in FIG. 1 of different shapes. The isolation can be less than −15 dB. Compared with the shape of the second decoupling element 140 shown in FIG. 1, the first section 142 and the third section 146 of the second decoupling element shown in FIG. 12B respectively extend from the edge adjacent to the receiving antenna 120 towards the edge closer to the receiving antenna 120, that is, extending inwardly from the edge adjacent to the receiving antenna 120. Due to the different shapes of the second decoupling element 140 in FIGS. 12A and 12B, the isolation characteristics between the transmitting antenna 130 and the receiving antenna 120 can produce a difference of about 5-10 dB. It can be understood that an array antenna module 1 can be combined by a plurality of the units 10 of array antenna module 1 as shown in FIGS. 12A and 12B. It can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. More specifically, in FIGS. 12A and 12B, the first spacing distance between the first decoupling element 150 and the transmit antenna 130 is 0.1 mm, and the second spacing distance between the second decoupling element 140 and the receive antenna 120 is 0.1 mm.

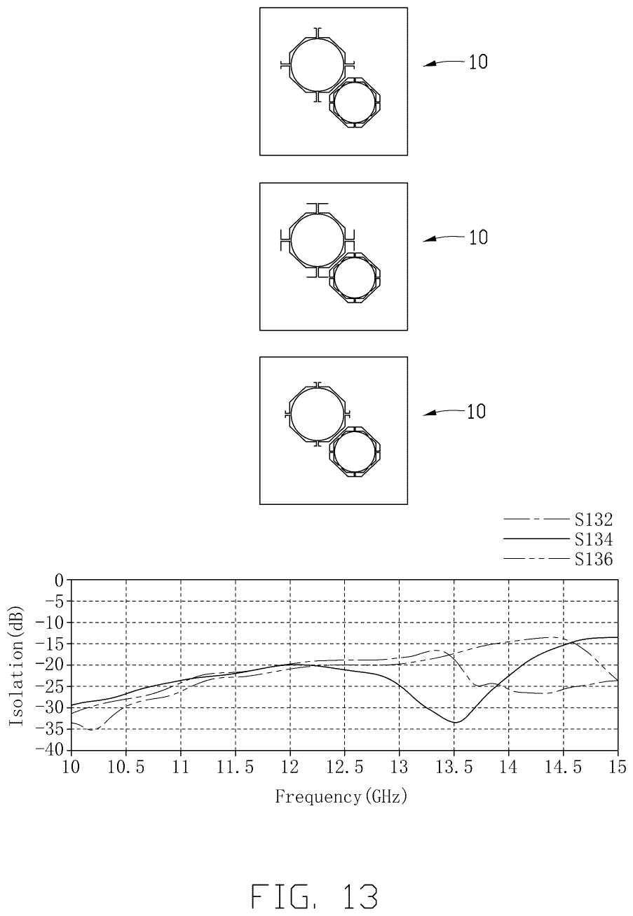

FIG. 13 is a schematic curve diagram of corresponding isolation when the unit 10 of array antenna module 1 according to the embodiment of the present application is provided with decoupling elements with different lengths. Curve S132 is an isolation when the length of the decoupling element of the unit 10 of array antenna module 1 is set to 1.0 wavelength of the operating band wavelength of the transmitting antenna and the receiving antenna, it can be seen that under this arrangement, the isolation in the low-orbit satellite Ku Band transmitting frequency band 14-14.5 GHz is less than −20 dB. Curve S132 is an isolation when the length of the decoupling element of the unit 10 of array antenna module 1 is set to 1.2 wavelength of the operating band wavelength of the transmitting antenna and the receiving antenna, it can be seen that under this arrangement, the isolation in the low-orbit satellite Ku Band transmitting frequency band 14-14.5 GHz is less than −15 dB. Curve S136 is an isolation when the length of the decoupling element of the unit 10 of array antenna module 1 is set to 0.8 wavelength of the operating band wavelength of the transmitting antenna and the receiving antenna, it can be seen that in this configuration, the isolation in the low-orbit satellite Ku Band transmitting frequency band 14-14.5 GHz is less than −10 dB. It can be understood that an array antenna module 1 can be combined by a plurality of the units 10 of array antenna module 1 as shown in FIG. 13. It can be implemented in a specific setting environment, where the distance between the transmitting antenna 130 and the receiving antenna 120 is approximately 1 mm, a first spacing distance between the first decoupling elements 150 and the transmitting antenna 130 is 0.1 to 0.5 mm, and a second spacing distance between the second decoupling elements 140 and the receiving antenna 120 is 0.1 to 0.5 mm. More specifically, in FIG. 13, the first spacing distance between the first decoupling element 150 and the transmit antenna 130 is 0.1 mm, and the second spacing distance between the second decoupling element 140 and the receive antenna 120 is 0.1 mm. It can be known that, in the situation of the first spacing distance between the first decoupling elements and the transmitting antenna is 0.1 to 0.5 mm, and the second spacing distance between the second decoupling elements and the receiving antenna is 0.1 to 0.5 mm, and when the length of the decoupling element is set to 0.9-1.0 wavelength of the operating band wavelength of the transmitting antenna and the receiving antenna, the isolation corresponding to the low-orbit satellite Ku Band transmission band 14-14.5 GHz is better (see curve S132 in FIG. 13).

The array antenna module 1 of the present application is provided with a plurality of first decoupling elements 150 between a plurality of transmitting antennas 130 and a plurality of receiving antennas 120, and arranged closer to the plurality of transmitting antennas 130, a plurality of second decoupling elements 140 between the plurality of transmitting antennas 130 and the plurality of receiving antennas 120, and arranged closer to the plurality of receiving antennas 120, which can effectively reduce the mutual coupling interference between the plurality of transmitting antennas 130 and receiving antennas 120, ensure the performance of the plurality of transmitting antennas 130 and receiving antennas 120, improve stability, and make the array antenna module 1 suitable for more wireless communication devices.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An array antenna module comprising:
a dielectric substrate;
at least one transmitting antenna and at least one receiving antenna arranged adjacent to each other and arranged on the dielectric substrate; and
at least one decoupling element arranged on the dielectric substrate, at least a part of the at least one decoupling element arranged between the at least one transmitting antenna and the at least one receiving antenna, the at least one decoupling element configured to improve an isolation between the at least one transmitting antenna and the at least one receiving antenna;
wherein the at least one decoupling element comprises a first decoupling element and a second decoupling element, the first decoupling element is arranged closer to the at least one transmitting antenna; the second decoupling element is arranged closer to the at least one receiving antenna.

2. The array antenna module of claim 1, wherein a length of the first decoupling element is 0.9 to 1.0 wavelength of an operating band wavelength of the at least one transmitting antenna, and a length of the second decoupling element is 0.9 to 1.0 wavelength of the operating band wavelength of the at least one receiving antenna.

3. The array antenna module of claim 1, wherein the at least one transmitting antenna is surrounded by the first decoupling element, the at least one receiving antenna is surrounded by the second decoupling element.

4. The array antenna module of claim 1, wherein the at least one transmitting antenna is surrounded by two first decoupling elements arranged at intervals, and the at least one receiving antenna is surrounded by two second decoupling elements arranged at intervals.

5. The array antenna module of claim 1, wherein the at least one transmitting antenna is surrounded by four first decoupling elements arranged at intervals, the four first decoupling elements are arranged alternately from end to end, and the at least one receiving antenna is surrounded by four second decoupling elements arranged at intervals, the four second decoupling elements are arranged alternately from end to end.

6. The array antenna module of claim 5, wherein each of the four second decoupling elements comprises a first section, a second section, and a third section connected in that order, the first section and the third section are symmetrically connected to opposite ends of the second section, the second section is spaced apart along an edge of the at least one receiving antenna.

7. The array antenna module of claim 5, wherein each of the four first decoupling elements comprises a fourth section, a fifth section, and a sixth section connected in that order, the fourth section and the sixth section are symmetrically connected to opposite ends of the fifth section, the fifth section is spaced apart along an edge of the at least one transmitting antenna.

8. The array antenna module of claim 5, wherein spacing positions of every two adjacent first decoupling elements are equally spaced along a circumferential direction of the at least one transmitting antenna;
spacing positions of every two adjacent second decoupling elements are equally spaced along a circumferential direction of the at least one receiving antenna.

9. The array antenna module of claim 1, further comprising:
a plurality of transmitting antennas arranged in rows, in each row of the plurality of transmitting antennas, every two adjacent transmitting antennas spaced apart by a second predetermined distance; and
a plurality of receiving antennas arranged in rows, in each row of the plurality of receiving antennas, every two adjacent receiving antennas spaced apart by a first predetermined distance, each of the plurality of receiving antenna is disposed staggered between two of the plurality of transmitting antennas,
wherein each row of the plurality of transmitting antennas and each row of the plurality of receiving antennas are disposed in offset positions to form an array disposed on the dielectric substrate;
each of the plurality of transmitting antennas is surrounded by the first decoupling element, each of the plurality of receiving antennas is surrounded by the second decoupling element.

10. The array antenna module of claim 1, wherein the dielectric substrate comprises a first substrate to an N^{th} substrate arranged in stack, N is a positive integer greater than or equal to 2, a surface of the first substrate away from the N^{th} substrate is provided with the at least one transmitting antenna and the at least one receiving antenna, a surface of the N^{th} substrate away from the first substrate is provided with a grounding layer.

11. A wireless communication device comprising an array antenna module, the array antenna module comprising:
a dielectric substrate;
at least one transmitting antenna and at least one receiving antenna arranged adjacent to each other and arranged on the dielectric substrate; and
at least one decoupling element arranged on the dielectric substrate, at least a part of the at least one decoupling element arranged between the at least one transmitting antenna and the at least one receiving antenna, the at least one decoupling element configured to improve an isolation between the at least one transmitting antenna and the at least one receiving antenna;
wherein the at least one decoupling element comprises a first decoupling element and a second decoupling element, the first decoupling element is arranged closer to the at least one transmitting antenna; the second decoupling element is arranged closer to the at least one receiving antenna.

12. The wireless communication device of claim 11, wherein a length of the first decoupling element is 0.9 to 1.0 wavelength of an operating band wavelength of the at least one transmitting antenna, and a length of the second decoupling element is 0.9 to 1.0 wavelength of the operating band wavelength of the at least one receiving antenna.

13. The wireless communication device of claim 11, wherein the at least one transmitting antenna is surrounded by the first decoupling element, the at least one receiving antenna is surrounded by the second decoupling element.

14. The wireless communication device of claim 11, wherein the at least one transmitting antenna is surrounded by two first decoupling elements arranged at intervals, and the at least one receiving antenna is surrounded by two second decoupling elements arranged at intervals.

15. The wireless communication device of claim 11, wherein the at least one transmitting antenna is surrounded by four first decoupling elements arranged at intervals, the four first decoupling elements are arranged alternately from end to end, and the at least one receiving antenna is surrounded by four second decoupling elements arranged at intervals, the four second decoupling elements are arranged alternately from end to end.

16. The wireless communication device of claim 15, wherein each of the four second decoupling elements comprises a first section, a second section, and a third section connected in that order, the first section and the third section are symmetrically connected to opposite ends of the second section, the second section is spaced apart along an edge of the at least one receiving antenna.

17. The wireless communication device of claim 15, wherein
each of the four first decoupling elements comprises a fourth section, a fifth section, and a sixth section connected in that order, the fourth section and the sixth section are symmetrically connected to opposite ends of the fifth section, the fifth section is spaced apart along an edge of the at least one transmitting antenna.

18. The wireless communication device of claim 15, wherein spacing positions of every two adjacent first decoupling elements are equally spaced along a circumferential direction of the at least one transmitting antenna;
spacing positions of every two adjacent second decoupling elements are equally spaced along a circumferential direction of the at least one receiving antenna.

19. The wireless communication device of claim 11, wherein the array antenna module further comprises:
a plurality of transmitting antennas arranged in rows, in each row of the plurality of transmitting antennas, every two adjacent transmitting antennas are spaced apart by a second predetermined distance;
a plurality of receiving antennas arranged in rows, in each row of the plurality of receiving antennas, every two adjacent receiving antennas are spaced apart by a first predetermined distance, each of the plurality of receiving antenna is disposed staggered between two of the plurality of transmitting antennas;
each row of the plurality of transmitting antennas and each row of the plurality of receiving antennas are disposed in offset positions to form an array disposed on the dielectric substrate;
each of the plurality of transmitting antennas is surrounded by the first decoupling element, each of the plurality of receiving antennas is surrounded by the second decoupling element.

20. The wireless communication device of claim 11, wherein the dielectric substrate comprises a first substrate to an N^{th} substrate arranged in stack, N is a positive integer greater than or equal to 2, a surface of the first substrate away from the N^{th} substrate is provided with the at least one transmitting antenna and the at least one receiving antenna, a surface of the N^{th} substrate away from the first substrate is provided with a grounding layer.
